(19) United States
(12) Patent Application Publication
(10) Pub. No.: US 2026/0326757 A1
(43) Pub. Date: Oct. 22, 2026

(54) Method and Device for Operating a Cruise Control System During a Lane Change

(71) Applicant: Bayerische Motoren Werke Aktiengesellschaft, Muenchen (DE)

(72) Inventors: Helena DOLINAJ, Muenchen (DE); Walter KAGERER, Muenchen (DE); Simon KNEBEL, Muenchen (DE)

(21) Appl. No.: 19/105,619

(22) PCT Filed: Aug. 17, 2023
(86) PCT No.: PCT/EP2023/072740

§ 371 Date: Feb. 21, 2025

(30) Foreign Application Priority Data
Aug. 24, 2022 (DE) 10 2022 121 424.9

(51) Int. Cl. B60W 30/14; B60W 30/18; B60W 50/10

(52) U.S. Cl. CPC B60W 30/143; B60W 30/18163; B60W 50/10; B60W 2552/10

(57) ABSTRACT

A device for operating a cruise control system of a vehicle. The device is configured to operate the cruise control system of the vehicle, while the vehicle is traveling in a first lane of a multi-lane road, at a target speed which depends on a first speed limit, which applies for the first lane. The device is further configured to detect that the vehicle is moving from the first lane into a second lane for which a second speed limit applies, and to adapt the target speed of the cruise control system to the second speed limit only once a change event has been detected.

### BACKGROUND AND SUMMARY

The invention relates to a method and a corresponding device which are directed towards a comfortable and safer operation of a cruise control system during a lane change.

A vehicle can have one or more driver assistance functions that support the driver of the vehicle in the longitudinal guidance of the vehicle. An exemplary driver assistance function is a distance and/or cruise control system (adaptive cruise control, ACC), which is set up to adjust the vehicle's driving speed as a function of a target speed and/or as a function of a target distance to a vehicle in front of the vehicle.

The driver assistance function can be designed to automatically set the target speed based on a speed limit that applies to the lane currently being driven on. Different speed limits may apply to different lanes of the road currently being driven on, which can lead to uncomfortable behavior of the driver assistance function during a lane change.

The present document addresses the technical problem of increasing the comfort of a cruise control system during a lane change.

The problem is solved by each of the independent claims. Advantageous embodiments are described, inter alia, in the dependent claims. It should be noted that additional features of a claim dependent on an independent claim can form a separate invention independent of the combination of all features of the independent claim, without the features of the independent claim or only in combination with a subset of the features of the independent claim, which can be made the subject of an independent claim, a divisional application or a subsequent application. This applies in the same way to technical teachings described in the description, which can form an invention independent of the features of the independent claims.

According to one aspect, a device for operating a cruise control system of a (motor) vehicle is described. The cruise control system can be operated in an automatic mode, in which the target speed is automatically adapted to the respective applicable speed limit (without requiring user input from the user of the vehicle).

The device is set up to operate the cruise control system of the vehicle at a target speed, which depends on the first speed limit that applies to the first lane, when the vehicle is traveling on a first lane of a multi-lane roadway. The device can also be set up to automatically adapt the target speed of the cruise control system to a changing first speed limit that applies to the first lane when the vehicle is traveling in the first lane. The change in the first speed limit can lead directly (without delay) to a corresponding change in the target speed. The target speed can correspond to the first speed limit in each case. The first speed limit can, for example, be recognized on the basis of the sensor data from one or more environment sensors (in particular cameras) of the vehicle. Alternatively or additionally, the first speed limit can be determined on the basis of data from a digital map relating to the road network traveled by the vehicle and/or on the basis of data from a (vehicle-external) backend server.

The device is also set up to recognize that the vehicle is changing from the first lane to a second lane of the roadway to which a second speed limit applies that differs from the first speed limit that applies to the first lane. The lane change can be recognized, for example, on the basis of sensor data from one or more environment sensors. For example, it can be recognized at a change time and/or at a change position that the vehicle is changing from the first lane to the second lane.

The second lane can be any other lane of the roadway traveled by the vehicle, wherein the second lane is different from the first lane. The second lane may be located directly next to the first lane. Alternatively, one or more other lanes of the roadway (which are crossed by the vehicle when the vehicle moves from the first lane to the second lane) may be located between the first lane and the second lane.

The second speed limit can, for example, be recognized on the basis of the sensor data from one or more environment sensors (in particular cameras) of the vehicle. Alternatively or additionally, the second speed limit can be determined on the basis of data from a digital map relating to the road network used by the vehicle and/or on the basis of data from a backend server (external to the vehicle).

Furthermore, the device is set up to adjust the target speed of the cruise control system to the second speed limit only after a change event has been recognized. In particular, the device can be set up to adapt the target speed of the cruise control system to the second speed limit after the recognized lane change to the second lane only after a change event has been recognized, although the cruise control system is operated in automatic mode. In the automatic mode of the cruise control system, the target speed of the cruise control system can be automatically adapted to a change in the speed limit that applies to the lane when the vehicle is traveling within a lane, without a change event having to be recognized.

In contrast to a change in the speed limit when driving within a lane, it is therefore possible to ensure that the speed limit is not automatically taken into account during a lane change, but only after a change event has been recognized, in order to determine the target speed of the cruise control system. In this way, the comfort of the cruise control system can be increased efficiently and reliably (especially in the event of a temporary lane change).

The device can be set up to control the target speed of the cruise control system (after the recognized lane change) until a change event is recognized. Alternatively or additionally, the device can be set up to adapt the target speed of the cruise control system to the second speed limit as soon as a change event is recognized. The second speed limit can be adopted as the target speed of the cruise control system in order to adapt the target speed of the cruise control system to the second speed limit. Furthermore, the device can be set up to automatically adapt the target speed of the cruise control system to a changing second speed limit that applies to the second lane when the vehicle is traveling in the second lane after the change event has been recognized. This means that the target speed can be automatically adapted to the applicable speed limit while driving in the second lane. This further increases the convenience of the cruise control system.

The device may be set up (during the automatic mode of the cruise control system) to recognize, following the recognized change of the vehicle to the second lane, that a change event from a set of (several) possible change events has occurred. The set of possible change events may include, for example: a user input (from the driver of the vehicle) at a user interface of the vehicle; the elapse of a predefined time period (e.g., 1 second or more, or 2 seconds or more) and/or a traversing of a predefined travel distance (e.g., 50 meters or more, or 100 meters or more) since the change to the second lane; and/or the passing of a signaling unit (a traffic sign) which (repeatedly) indicates the second speed limit that applies to the second lane. The target speed of the cruise control system can then be adapted to the second speed limit that applies to the second lane in response to the recognized change event. By taking into account several possible change events, the comfort of the cruise control system can be further increased during a lane change.

In particular, the target speed of the cruise control system can only be adapted to the second speed limit at a change point in time and/or at a change position, wherein the change point in time and/or the change position follow the change point in time and/or the change position. The change event can be recognized at or before the change time and/or the change position.

Following the recognized change of the vehicle from the first lane to the second lane (although the cruise control system is operated in an automatic mode), the device can be set up so that an offer to adjust the target speed to the second speed limit that applies to the second lane is issued via the user interface of the vehicle. A user input to accept the offer to adjust the target speed can then be recognized as a change event.

Alternatively or additionally, the device can be set up to recognize as a change event that the predefined time period and/or the predefined travel distance has elapsed and/or has been traveled since the change time and/or since the change position at which the change from the first lane to the second lane was recognized.

Alternatively or additionally, the device can be set up to recognize as a change event, in particular on the basis of sensor data from one or more environment sensors of the vehicle, that the vehicle passes a signaling unit (a traffic sign for the speed limit) following the change to the second lane, by means of which the second speed limit that applies in the second lane is indicated.

The speed limits for several different lanes, in particular for the first lane and for the second lane, of the roadway used by the vehicle can be displayed by the signaling unit. The device can be set up to identify (e.g., on the basis of data from the digital map and/or on the basis of the sensor data from the one or more environment sensors) the second speed limit that applies to the second lane from the several speed limits displayed.

One or more of the above-mentioned change events can particularly increase the comfort of the cruise control system.

The device can be set up to recognize while driving in the first lane, before the lane change from the first lane to the second lane, that a multi-lane limit situation exists on the lane used by the vehicle, in which different speed limits apply for different lanes, in particular for the first lane and for the second lane.

Even if a multi-lane limit situation is recognized, the target speed of the cruise control system can be automatically adapted to a changing speed limit when driving within a lane without checking a change event (to operate the cruise control system in automatic mode).

On the other hand, in response to the recognized multi-lane limit situation (even if the cruise control system is operated in automatic mode), the target speed of the cruise control system is not adjusted to the speed limit that applies to the respective lane immediately after the recognized lane change, but only after a change event has been recognized. In this way, the comfort of the cruise control system can be increased in a particularly reliable manner.

The device can be set up to determine whether the second speed limit is higher or lower than the first speed limit. The target speed of the cruise control system can only be adapted to the second speed limit after a change event has been recognized if the second speed limit is greater than the first speed limit. On the other hand, the target speed of the cruise control system can be automatically adapted to the second speed limit, without the need for a change event, if the second speed limit is lower than the first speed limit. In this way, the comfort of the cruise control system can be further increased.

According to a further aspect, a (road) motor vehicle (a passenger car or a truck or a bus or a motorcycle) is described which comprises the device described in this document.

According to a further aspect, a method for operating a cruise control system of a (motor) vehicle is described. The method comprises operating the cruise control system of the vehicle while the vehicle is traveling on a first lane of a multi-lane roadway at a target speed that depends on the first speed limit that applies to the first lane (wherein the target speed may be automatically adjusted (without time delay) to the changing first speed limit while the vehicle is traveling on the first lane).

The method further comprises recognizing that the vehicle is changing from the first lane to a second lane to which a second speed limit applies that is different from the first speed limit that applies to the first lane. Furthermore, the method comprises adapting the target speed of the cruise control system to the second speed limit only after a change event has been recognized.

According to a further aspect, a software (SW) program is described. The SW program may be set up to be executed on a processor (e.g., a control unit of a vehicle), and thereby to perform the method described in this document.

According to a further aspect, a storage medium is described. The storage medium may comprise an SW program arranged to be executed on a processor and thereby to perform the method described in this document.

It should be noted that the methods, devices and systems described in this document can be used alone or in combination with other methods, devices and systems described in this document. Furthermore, any aspects of the methods, devices and systems described in this document can be combined with each other in a variety of ways. In particular, the features of the claims may be combined with each other in a variety of ways. Furthermore, features listed between parentheses are to be understood as optional features.

The invention is described in greater detail below with reference to exemplary embodiments, in which:

### BRIEF DESCRIPTION OF THE DRAWINGS

FIG. 1 shows exemplary components of a vehicle;

FIG. 2 shows an exemplary multi-lane roadway with lane-specific speed limits; and

FIG. 3 shows a flow chart of an exemplary method for operating a cruise control system during a lane change.

### DETAILED DESCRIPTION OF THE DRAWINGS

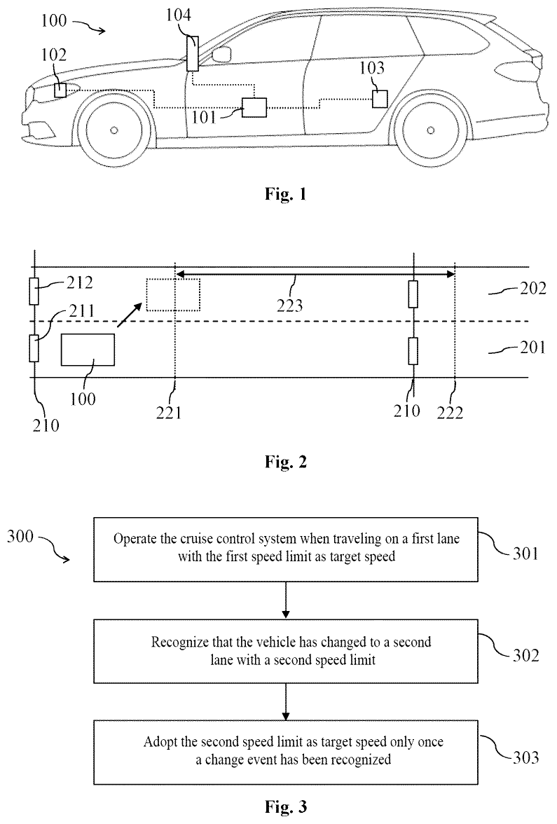

As stated at the outset, the present document is concerned with increasing the comfort of a cruise control system during a lane change on a multi-lane roadway with lane-specific speed limits. In this regard, FIG. 1 shows an exemplary vehicle 100 having one or more environment sensors 102 (e.g., one or more cameras, one or more radar sensors, one or more lidar sensors, and/or one or more ultrasonic sensors). The vehicle 100 further comprises one or more longitudinal and/or lateral guidance actuators 103 (e.g., a drive motor, a braking device, and/or a steering device) configured to effect automated longitudinal and/or lateral guidance of the vehicle 100.

A (control) device 101 of the vehicle 100 can be set up to operate the one or more actuators 103 as a function of the sensor data from the one or more environment sensors 102 to provide a driver assistance function. In particular, an automatic cruise control and/or distance control system can be effected. As part of the automatic cruise control system, the driving speed of the vehicle 100 can be automatically set to a specific target speed. The target speed may have been specified by the driver of the vehicle 100 via a user interface 104 of the vehicle 100. Alternatively or additionally, the target speed can be determined automatically on the basis of the sensor data of the one or more environment sensors 102, e.g., as the currently applicable speed limit (indicated by a traffic sign).

FIG. 2 shows an exemplary driving situation in which the vehicle 100 is driving on a multi-lane roadway with a first lane 201 and a second lane 202. A first speed limit may be present on the first lane 201, which is indicated, for example, by a first signaling unit 211 of a signaling bridge 210. A second speed limit may be present on the second lane 202, which is indicated, for example, by a second signaling unit 212 of the signaling bridge 210. The first and second speed limits may be different.

The vehicle 100 can be automatically guided longitudinally on the first lane 201 with active cruise control system (and possibly automatically guided transversely by a lane departure warning system). The first speed limit may have been defined as the target speed of the cruise control system, so that the vehicle 100 is guided longitudinally in the first lane 201 at a first driving speed that is dependent on the first speed limit.

At a change position or at a change time 221, the vehicle 100 may change lanes to the second lane 202. This may result in a second target speed being automatically set for the cruise control system, which depends on the second speed limit (e.g., corresponding to the second speed limit). This may be perceived as inconvenient by the driver of the vehicle 100, particularly if only a temporary change to the second lane 202 has been performed.

The device 101 can be set up to delay the adjustment of the target speed of the cruise control system to the second speed limit of the second lane 202 and only to perform it after a change event has occurred. The adjustment of the target speed can then be carried out in response to the change event.

Examples of change events are:
recognizing a signaling bridge 210 and/or a signaling unit 212 for indicating the second speed limit on the second lane 202;
the elapse of a change time period and/or the traversing of a travel distance 223 since the change time or since the change position 221 at which the lane change to the second lane 202 took place; and/or
a confirmation by the driver of the vehicle 100 via the user interface 104 of the vehicle 100 that the target speed of the cruise control system should be adapted to the second lane 202.

If necessary, several possible change events can be defined. The device 101 can be set up to recognize whether at least one change event has occurred. If this is the case, it can automatically cause the target speed of the cruise control system to be adapted to the second lane 202, to the second speed limit of the second lane 202. In this way, the comfort of the cruise control system can be increased in an efficient and reliable manner.

It can therefore be perceived as uncomfortable by a driver if the setting speed (i.e., the target speed) changes during a lane change and the vehicle 100 decelerates or accelerates accordingly, in particular if another lane 202 is used for a short time.

The device 101 can be set up to recognize the existence of a multi-lane limit situation. When entering the multi-lane limit situation, the limit (i.e., the speed limit) that applies to the lane 201 currently being used is automatically adopted. If the driver changes lanes, the new limit of the other lane 202 is not initially adopted, but the driver can be offered the option of adopting the new limit via the user interface 104. The driver can accept the new limit by means of an operating action. Alternatively or additionally, the device 101 can monitor whether the driver is driving in the new lane 202 for a longer time period. The new limit can be adopted automatically (at a change position or at a change time 222) when a set dwell time or travel distance 223 on the new lane 202 has elapsed.

If the speed limits on the respective lane 201, 202 are changed, the limit that applies to this lane 201, 202 is automatically adopted again. At the end of the multi-lane limit situation, i.e., when the same limit applies to all lanes 201, 202 again, this limit can be adopted automatically.

FIG. 3 shows a flow chart of a (possibly computer-implemented) method 300 for operating a cruise control system of a vehicle 100. The cruise control system is set up to automatically adjust the driving speed of the vehicle 100 as a function of a predetermined target speed, to control it to the target speed. The target speed may have been predetermined by the driver of the vehicle 100 and/or the target speed may have been set automatically on the basis of a speed limit.

The method 300 comprises operating 301 the cruise control system of the vehicle 100 when the vehicle 100 is traveling on a first lane 201 of a multi-lane roadway at a target speed that depends on the first speed limit that applies to the first lane 201. The target speed may have been set automatically as a function of the first speed limit. In particular, the target speed may correspond to the first speed limit. Furthermore, the cruise control system can be operated in an automatic mode, so that the target speed is automatically adapted to a changing first speed limit while driving in the first lane 201.

The method 300 further comprises recognizing 302 that the vehicle 100 is changing from the first lane 201 to a second lane 202 of the multi-lane roadway to which a second speed limit applies that is different from the first speed limit that applies to the first lane 201. When a lane change is recognized, the cruise control system can continue to be operated in the automatic mode for automatically adapting the target speed to the applicable speed limit. Furthermore, it may already have been recognized before the lane change that there is a second speed limit for the second lane 202, which differs from the first speed limit. In particular, it may have been recognized (even before the lane change) that a multi-lane limit driving situation exists in which different speed limits apply to different lanes 201, 202.

The method 300 further comprises adapting 303 the target speed of the cruise control system to the second speed limit only after a change event has been recognized. It is thus possible (in deviation from the automatic adaptation to the respective applicable speed limit) to adapt the target speed to the second speed limit only when a change event is recognized.

As part of the method 300, it can be recognized that the vehicle 100 has switched back (from the second lane 202) to the first lane 201 (e.g., as a result of a relatively short overtaking maneuver) before a change event occurs and/or is recognized. In this case, an offer (issued or to be issued via the user interface 104) to adjust the target speed to the second speed limit can be automatically withdrawn or suppressed if necessary.

The measures described in this document can increase the comfort of a cruise control system of a vehicle 100 in an efficient and reliable manner.

The present invention is not limited to the exemplary embodiments presented. In particular, it should be noted that the description and the figures are merely intended to illustrate the principle of the proposed methods, devices and systems by way of example.

1.-15. (canceled)

16. A device for operating a cruise control system of a vehicle, wherein the device is configured to:
operate the cruise control system of the vehicle based on a determination that the vehicle is traveling on a first lane of a multi-lane roadway at a target speed which depends on a first speed limit that applies to the first lane;
recognize that the vehicle is changing from the first lane to a second lane to which a second speed limit applies that is different from the first speed limit that applies to the first lane; and
adjust the target speed of the cruise control system to the second speed limit only after a change event has been recognized.

17. The device according to claim 16, wherein the device is configured to:
recognize at a first change time and/or at a first change position that the vehicle is changing from the first lane to the second lane; and
adapt the target speed of the cruise control system to the second speed limit only at a second change time and/or at a second change position; wherein
the second change time and/or the second change position follows the first change time and/or the first change position; and/or
the change event is recognized at or before the second change time and/or the second change position.

18. The device according to claim 16, wherein the device is configured to:
following the recognized change of the vehicle from the first lane to the second lane, cause an offer to adjust the target speed to the second speed limit that applies to the second lane to be issued via a user interface of the vehicle; and
recognize a user input to accept the offer to adjust the target speed as the change event.

19. The device according to claim 16, wherein the device is configured to recognize as the change event that a predefined time period and/or a predefined travel distance has elapsed and/or has been traversed since a change time and/or since a change position at which the change from the first lane to the second lane was recognized.

20. The device according to claim 16, wherein the device is configured to recognize as the change event, based on sensor data from one or more environment sensors of the vehicle, that the vehicle, following the change to the second lane, passes a signaling unit indicating that the second speed limit applies to the second lane.

21. The device according to claim 16, wherein the device is configured to leave the target speed of the cruise control system unchanged until the change event is recognized.

22. The device according to claim 16, wherein the device is configured to adapt the target speed of the cruise control system to the second speed limit as soon as the change event is recognized.

23. The device according to claim 16, wherein the device is configured to:
recognize, following the recognized change of the vehicle to the second lane, that the change event is from a set of possible change events; wherein the set of possible change events comprises
a user input at a user interface of the vehicle
an elapse of a predefined period of time and/or a traversing of a predefined travel distance since the change to the second lane; and/or
the passing of a signaling unit which indicates the second speed limit that applies to the second lane; and
adapt the target speed of the cruise control system to the second speed limit that applies to the second lane in response to the change event.

24. The device according to claim 16, wherein the device is configured to adopt the second speed limit as the target speed of the cruise control system to adapt the target speed of the cruise control system to the second speed limit.

25. The device according to claim 16, wherein the device is configured to adapt the target speed of the cruise control system to the second speed limit after the lane change to the second lane only after the change event has been recognized, although the cruise control system is operated in an automatic mode, in which, during a journey of the vehicle within the first lane or the second lane, without the change event having to be recognized for this purpose, an automatic adaptation of the target speed of the cruise control system to a change in the speed limit that applies to the first lane or the second lane takes place.

26. The device according to claim 16, wherein the device is configured to:
automatically adjust the target speed of the cruise control system to a changing first speed limit that applies to the first lane when the vehicle is traveling in the first lane; and/or
after recognizing the change event, automatically adapt the target speed of the cruise control system to a changing second speed limit that applies to the second lane when the vehicle is traveling in the second lane.

27. The device according to claim 16, wherein the device is configured to:
recognize while driving on the first lane, before the lane change from the first lane to the second lane, that a multi-lane limit situation exists on the roadway driven on by the vehicle, in which different speed limits apply for different lanes, including for the first lane and for the second lane of the roadway; and
in response to recognition of the multi-lane limit situation, not adjust the target speed of the cruise control system to the speed limit that applies to a respective lane immediately after the lane change, but only after the change event has been recognized.

28. The device according to claim 27, wherein the device is configured to automatically adapt the target speed of the cruise control system to a changing speed limit during a journey within the first or second lane without checking the change event, even if a multi-lane limit situation is recognized.

29. The device according to claim 16, wherein the device is configured to:
determine whether the second speed limit is higher or lower than the first speed limit;
adjust the target speed of the cruise control system to the second speed limit only after the change event has been recognized, if the second speed limit is greater than the first speed limit; and/or
automatically adjust the target speed of the cruise control system to the second speed limit, without requiring the change event, if the second speed limit is lower than the first speed limit.

30. A method for operating a cruise control system of a vehicle, the method comprising:
operating the cruise control system of the vehicle when the vehicle is traveling on a first lane of a multi-lane roadway at a target speed which is dependent on a first speed limit that applies to the first lane;
recognizing that the vehicle is changing from the first lane to a second lane to which a second speed limit applies that is different from the first speed limit that applies to the first lane; and
adjusting the target speed of the cruise control system to the second speed limit only after a change event has been recognized.
